(19) United States
(12) Patent Application Publication
(10) Pub. No.: US 2023/0257591 A1
(43) Pub. Date: Aug. 17, 2023

(54) LAMINATE FOR RADIATIONAL COOLING AND MATERIAL FOR RADIATIONAL COOLING CONTAINING THE SAME

(71) Applicants: HYUNDAI MOTOR COMPANY, SEOUL (KR); KIA CORPORATION, SEOUL (KR)

(72) Inventor: Min Jae Lee, Seongnam-si (KR)

(21) Appl. No.: 17/832,529

(22) Filed: Jun. 3, 2022

(30) Foreign Application Priority Data
Feb. 11, 2022 (KR) 10-2022-0018452

(51) Int. Cl. C09D 5/33; C09D 175/04; C09D 17/00

(52) U.S. Cl. CPC C09D 5/004; C09D 175/04; C09D 17/008; C09D 17/007; C09D 17/004

(57) ABSTRACT

The present disclosure relates to a laminate for radiational cooling including a substrate layer containing a matrix of an infrared light-radiating polymer containing polycarbonate-based polyurethane and particles of a visible light-reflecting inorganic material, and an ultraviolet light-reflecting coating layer formed on the substrate layer and containing an ultra-high molecular polyolefin-based polymer. The ultraviolet light-reflecting coating layer is porous, and particles of an ultraviolet light-reflecting inorganic material disposed in pores of the ultraviolet light-reflecting coating layer.

### CROSS-REFERENCE TO RELATED APPLICATION

This application claims the benefit of priority to Korean Patent Application No. 10-2022-0018452, filed in the Korean Intellectual Property Office on Feb. 11, 2022, the entire contents of which are incorporated herein by reference.

### TECHNICAL FIELD

The present disclosure relates to a laminate for radiational cooling that has excellent flexibility, has a thickness providing for easy control, and has excellent infrared light radiability and ultraviolet light reflectivity, and a radiational cooling material containing the same.

### BACKGROUND

In general, the consumption of energy is essential for cooling. For example, general purpose cooling devices such as a refrigerator, an air conditioner, and the like compress a refrigerant using the energy and then perform the cooling using absorption of heat occurred when the compressed refrigerant is expanded. Radial cooling is a technology for the cooling without consuming the energy, unlike the general-purpose cooling devices. In order to improve a radiational cooling efficiency, it is important to well control absorbency, reflectivity, and emissivity of light in each wavelength band. Most of the heat comes from incident sunlight, and the sunlight is divided into ultraviolet (UV) light, visible light, and infrared light. When reflecting the light in each wavelength band, it is possible to block inflow of the heat through the sunlight. For example, during the day when the sun is shining, an internal temperature of a black vehicle that absorbs the light well will easily increase, but an internal temperature of a white vehicle that does not absorb the light relatively and reflects the light well will increase in a relatively slow manner.

As a material for such radiational cooling, various materials such as a polymer, a multilayer thin film of an inorganic material or a ceramic material, a radiational cooling material including a metal reflective layer, and a paint containing a white pigment are being used. The polymer material generally has a high absorption rate (radiation rate) with respect to the infrared light, but has a short lifespan by being easily deteriorated by the ultraviolet light, moisture, and the like when left outdoors because of the nature of the material. In the case of the multilayer thin film, the number of layers must be increased to increase the radiation rate with respect to the infrared light, which increases an absorption rate of the sunlight, thereby making it difficult to achieve a high-efficiency radiational cooling performance. In addition, the material including the metal reflective layer is difficult to be applied in real life because of problems of low long-term stability resulted from oxidation of the metal and a unit cost, and such metal material causes eye fatigue and light blur because of specular reflection. The paint containing the white pigment is not usually composed of a material having a high extinction coefficient, and thus, has insufficient infrared light radiation rate and ultraviolet light reflection rate, so that a radiational cooling ability is insufficient.

As an alternative to such a problem, Korean Patent No. 2154072 (Patent Document 1) discloses a coolant capable of realizing a color in the radiational cooling, containing a first material that causes the radiational cooling by emitting the infrared light, and a second material that absorbs light in a visible light region, changes a wavelength of the light, and emits the light whose wavelength is changed. However, as in Patent Document 1, the coolant in which the second material such as a dye, a semiconductor material, or the like is mixed with the first material that emits the infrared light by electromagnetic resonance has a problem in that the ultraviolet light reflection rate is low, and thus the radiational cooling ability is insufficient.

Therefore, there is a need for research and development of a material that has excellent flexibility, has a thickness providing for easy control, and has excellent infrared light radiability and ultraviolet light reflectivity to have the excellent radiational cooling ability.

### SUMMARY

The present disclosure has been made to solve the above-mentioned problems occurring in the prior art while advantages achieved by the prior art are maintained intact.

An aspect of the present disclosure provides a laminate that has excellent flexibility, has a thickness providing for easy control, and has excellent infrared light radiability and ultraviolet light reflectivity so as to have an excellent radiational cooling ability, and a radiational cooling material containing the same.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a laminate for radiational cooling includes a substrate layer containing a matrix of an infrared light-radiating polymer containing polycarbonate-based polyurethane and particles of a visible light-reflecting inorganic material, an ultraviolet light-reflecting coating layer formed on the substrate layer and containing an ultra-high molecular polyolefin-based polymer, wherein the ultraviolet light-reflecting coating layer is porous, and particles of an ultraviolet light-reflecting inorganic material disposed in pores of the ultraviolet light-reflecting coating layer.

According to another aspect of the present disclosure, a radiational cooling material contains the laminate for the radiational cooling.

According to another aspect of the present disclosure, a vehicle contains the radiational cooling material.

### BRIEF DESCRIPTION OF THE DRAWINGS

The above and other objects, features and advantages of the present disclosure will be more apparent from the following detailed description taken in conjunction with the accompanying drawings:

FIG. 1 is a cross-sectional view of a laminate for radiational cooling according to an embodiment of the present disclosure;

FIG. 2 are graphs 250 of reflection rates of ultraviolet light and visible light and graphs of radiation rates of infrared light measured in an embodiment of the present disclosure;

FIG. 3 are graphs 350 of reflection rates of ultraviolet light and visible light and graphs of radiation rates of infrared light measured in an embodiment of the present disclosure; and

FIG. 4 are graphs 450 of reflection rates of ultraviolet light and visible light and graphs of radiation rates of infrared light measured in an embodiment of the present disclosure.

### DETAILED DESCRIPTION

In the present specification, when a certain portion “includes” a certain component, this means that other components may be further included without being excluded unless otherwise stated.

In the present specification, when a first member is said to be located on a “surface” of or “on” a second member, this includes not only a case in which the first member is in contact with the second member, but also a case in which a third member exists between the two members.

Laminate for Radiational Cooling

A laminate for radiational cooling according to the present disclosure includes a substrate layer containing a matrix of an infrared light-radiating polymer and particles of a visible light-reflecting inorganic material, an ultraviolet light-reflecting coating layer formed on the substrate layer, and particles of an ultraviolet light-reflecting inorganic material disposed in pores of the ultraviolet light-reflecting coating layer.

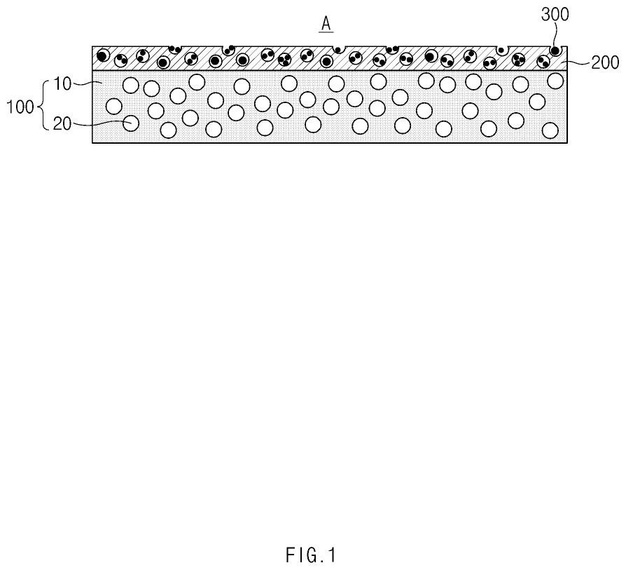

Referring to FIG. 1, a laminate A for the radiational cooling according to the present disclosure may include a substrate layer 100, an ultraviolet light-reflecting coating layer 200 formed on the substrate layer 100, and particles 300 of an ultraviolet light-reflecting inorganic material disposed in pores of the ultraviolet light-reflecting coating layer 200.

The substrate layer 100 may contain a matrix 10 of an infrared light-radiating polymer and particles 20 of a visible light-reflecting inorganic material.

Substrate Layer

The substrate layer serves to emit heat via visible light reflection and infrared light radiation. In this regard, the substrate layer contains the matrix of the infrared light-radiating polymer and the particles of the visible light-reflecting inorganic material. Referring to FIG. 1, the substrate layer 100 may be in a form in which the particles 20 of the visible light-reflecting inorganic material are dispersed in the matrix 10 of the infrared light-radiating polymer.

The infrared light-radiating polymer serves to lower a temperature of the laminate by radiating the heat of the laminate in a form of infrared light and exporting the heat to space.

The infrared light-radiating polymer includes polycarbonate-based polyurethane (PCU). In this regard, the polycarbonate-based polyurethane is a polymer prepared by reacting a polyol containing polycarbonate with a polyisocyanate. Because the infrared light-radiating polymer contains the PCU, there is an effect of effectively absorbing an infrared light wavelength to increase a radiation rate.

The polycarbonate-based polyurethane may have a weight-average molecular weight (Mw) in a range from 450 to 4,500 g/mol, specifically, in a range from 600 to 3,000 g/mol. When the weight-average molecular weight of the polycarbonate-based polyurethane is within the above range, an infrared light radiation rate is excellent, which is preferable.

The visible light-reflecting inorganic material serves to lower the temperature of the laminate by reflecting visible light incident on the laminate.

In addition, the visible light-reflecting inorganic material may include at least one selected from a group consisting of TiO₂, SiO₂, ZnO, CaCO₃, BaSO₄, and Al₂O₃. Specifically, the visible light-reflecting inorganic material may include at least one selected from a group consisting of TiO₂, SiO₂, and ZnO.

The particles of the visible light-reflecting inorganic material may have an average particle diameter in a range from 50 to 1,500 nm. Specifically, the particles of the visible light-reflecting inorganic material may have an average particle diameter in a range from 200 to 1,200 nm or in a range from 200 to 800 nm. When the average particle diameter of the particles of the visible light-reflecting inorganic material is less than the above range and exceeds the above range, because a visible light scattering effect is lowered, the reflection rate may be reduced.

A shape of the particles of the visible light-reflecting inorganic material is not particularly limited as long as the material is an inorganic material that reflects the visible light. For example, the particles may be spheric or amorphous. In some example embodiments, the particles may be spherical.

The substrate layer may contain the visible light-reflecting inorganic material and the infrared light-radiating polymer in a weight ratio of 0.5 to 5.0:1, a weight ratio of 0.8 to 4.0:1, or a weight ratio of 1.0 to 3.0:1. When the weight ratio of the visible light-reflecting inorganic material and the infrared light-radiating polymer is less than the above ranges, that is, when a small amount of the visible light-reflecting inorganic material is contained with respect to a weight of the infrared light-radiating polymer, a visible light reflection rate may be reduced. In addition, when the weight ratio of the visible light-reflecting inorganic material and the infrared light-radiating polymer exceeds the above range, that is, when an excessive amount of the visible light-reflecting inorganic material is contained with respect to the weight of the infrared light-radiating polymer, the visible light reflection rate may be reduced or the infrared light radiation rate may be reduced.

In addition, the substrate layer may have an average thickness in a range from 200 μm to 1 mm or in a range from 300 to 400 μm. When the average thickness of the substrate layer is less than the above range, the temperature of the laminate may increase as the visible light reflection rate is reduced or the infrared light radiation rate is reduced. When the average thickness of the substrate layer exceeds the above range, flexibility of the manufactured laminate may be lowered.

Ultraviolet Light-reflecting Coating Layer

The ultraviolet light-reflecting coating layer serves to lower the temperature of the laminate by reflecting the ultraviolet light incident on the laminate.

Referring to FIG. 1, the ultraviolet light-reflecting coating layer 200 is formed on the substrate layer 100. In this regard, the ultraviolet light-reflecting coating layer contains an ultra-high molecular polyolefin-based polymer and is porous. Because the ultraviolet light-reflecting coating layer contains a polyolefin-based polymer having a long chain of an ultra-high molecular weight, resistance to the ultraviolet light is high, and thus, ultraviolet light reflexibility is excellent. In addition, because the ultraviolet light-reflecting coating layer is porous, there is an effect that an ultraviolet light reflection rate is improved.

The ultra-high molecular polyolefin-based polymer refers to a polyolefin-based polymer having a long chain, with a molecular weight of several million. For example, the ultra-high molecular polyolefin-based polymer may include ultra-high molecular polyethylene (UMPE). When the ultra-high molecular polyolefin-based polymer includes the UMPE, the ultraviolet light resistance is improved because of the ultra-high molecular weight long chain.

In addition, the ultra-high molecular polyolefin-based polymer may have a weight-average molecular weight in a range from 3,000,000 to 6,000,000 g/mol, specifically, in a range from 3,000,000 to 4,000,000 g/mol. When the weight-average molecular weight of the ultra-high molecular polyolefin-based polymer is within the above range, the porosity of the prepared ultraviolet light-reflecting coating layer is appropriate. In addition, when the weight-average molecular weight of the ultra-high molecular polyolefin-based polymer is less than the above range, durability of the manufactured laminate is insufficient. When the weight-average molecular weight of the ultra-high molecular polyolefin-based polymer exceeds the above range, the porosity of the prepared ultraviolet light-reflecting coating layer is lowered, so that the ultraviolet light reflection rate may be lowered.

The ultraviolet light-reflecting coating layer may have pores having an average diameter in a range from 5 to 25 μm. Specifically, the ultraviolet light-reflecting coating layer may have pores having an average diameter in a range from 10 to 25 μm or in a range from 14 to 20 μm. When the average diameter of the pores in the ultraviolet light-reflecting coating layer is less than the above range, the ultraviolet light reflection rate is reduced and transfer of convective heat from the outside increases, so that the temperature of the laminate may increase. When the average diameter of the pores exceeds the above range, the ultraviolet light reflection rate of the manufactured laminate may be reduced.

In addition, the ultraviolet light-reflecting coating layer may have a porosity in a range from 20 to 40% or from 25 to 35%. When the porosity of the ultraviolet light-reflecting coating layer is less than the above range, the ultraviolet light reflection rate is reduced and the transfer of the convective heat from the outside increases, so that the temperature of the laminate may increase. When the porosity of the ultraviolet light-reflecting coating layer exceeds the above range, a commercial value of the laminate may be deteriorated as excessive pores are contained.

The ultraviolet light-reflecting coating layer may have an average thickness in a range from 50 to 500 μm or from 100 to 300 μm. When the average thickness of the ultraviolet light-reflecting coating layer is less than the above range, the ultraviolet light reflection rate is reduced and the transfer of the convective heat from the outside increases, so that the temperature of the laminate may increase. When the average thickness of the ultraviolet light-reflecting coating layer exceeds the above range, economic feasibility of the laminate may be lowered because a yield is small compared to the thickness of the ultraviolet light-reflecting coating layer.

Ultraviolet Light-reflecting Inorganic Material

The particles of the ultraviolet light-reflecting inorganic material disposed in the pores of the ultraviolet light-reflecting coating layer are included. That is, a diameter of the particles of the ultraviolet light-reflecting inorganic material is smaller than that of the pores of the ultraviolet light-reflecting coating layer.

In addition, the ultraviolet light-reflecting inorganic material may have a band gap greater than 4.0 eV. Specifically, the ultraviolet light-reflecting inorganic material may have the band gap in a range from 4.0 to 10.0 eV or in a range from 5.0 to 10.0 eV. When the band gap of the ultraviolet light-reflecting inorganic material is less than the above range, because the ultraviolet light reflexibility of the inorganic material is insufficient, the ultraviolet light reflexibility of the manufactured laminate may be insufficient.

The ultraviolet light-reflecting inorganic material may include at least one selected from a group consisting of BaSO₄, CaCO₃, and Al₂O₃.

In addition, the particles of the ultraviolet light-reflecting inorganic material may have an average particle diameter in a range from 100 to 500 nm or in a range from 200 to 300 nm. When the average particle diameter of the ultraviolet light-reflecting inorganic material is less than the above range, the ultraviolet light reflection rate of the laminate may be reduced. When the average particle diameter of the ultraviolet light-reflecting inorganic material exceeds the above range, the ultraviolet light reflection rate of the laminate may be reduced.

A weight of the particles of the ultraviolet light-reflecting inorganic material in a unit volume of the ultraviolet light-reflecting coating layer may be in a range from 0.1 to 1 g/ml or in a range from 0.1 to 0.5 g/ml. When the weight of the particles of the ultraviolet light-reflecting inorganic material is less than the above range, the ultraviolet light reflection rate of the laminate may be reduced. When the weight of the particles of the ultraviolet light-reflecting inorganic material exceeds the above range, the ultraviolet light reflection rate of the laminate may be reduced.

The laminate for the radiational cooling may have a reflection rate in a range from 65 to 99% for a wavelength in a range from 200 to 400 nm and have a reflection rate in the range from 65 to 99% for a wavelength in a range from 400 to 700 nm. Specifically, the laminate for the radiational cooling may have a reflection rate in a range from 70 to 95% for the wavelength in the range from 200 to 400 nm and have a reflection rate in the range from 70 to 95% for the wavelength in the range from 400 to 700 nm. That is, the laminate for the radiational cooling has excellent reflection rates for the ultraviolet light having the wavelength in the range from 200 to 400 nm and the visible light having the wavelength in the range from 400 to 700 nm, so that the laminate for the radiational cooling is very suitable as a material for the radiational cooling.

In addition, the laminate for the radiational cooling may have an average thickness in a range from 50 to 800 μm or in a range from 100 to 500 μm.

The laminate for the radiational cooling according to the present disclosure as described above has excellent flexibility, has a thickness providing for easy control, and has excellent infrared light radiability and ultraviolet light reflectivity to have the excellent radiational cooling ability. Therefore, the laminate for the radiational cooling may be suitably used as a material in various fields requiring a material having the excellent radiational cooling ability, such as a vehicle.

Radiational Cooling Material

The radiational cooling material of the present disclosure contains the laminate for the radiational cooling.

As described above, the radiational cooling material contains the laminate for the radiational cooling excellent in the ultraviolet light and visible light reflectivity and excellent in the infrared light radiability, so that the radiational cooling material may be suitably used as the material in the various fields requiring the material with the excellent radiational cooling ability, such as the vehicle.

Vehicle

The vehicle of the present disclosure contains the radiational cooling material. For this reason, the vehicle is excellent in energy efficiency because it is possible to save cooling energy in summer.

Hereinafter, the present disclosure will be described in more detail through Examples. However, such Examples are only for helping the understanding of the present disclosure, and the scope of the present disclosure is not limited to such Examples in any sense.

### EXAMPLES

### Preparation Example 1

The polycarbonate-based polyurethane (manufacturer: BASF, product name: Ellatollan, and Mw: 1,000 g/mol) as the infrared light-radiating polymer and TiO₂ (average particle diameter: 360 nm) as the visible light-reflecting inorganic material were mixed with each other in a weight ratio of 1:1, and then, applied and dried to prepare a substrate layer-1 having a thickness of 400 μm.

A UMPE film (manufacturer: Nitto Denko, product name: SUNMNAP, thickness: 100 μm, average pore diameter: 17 μm, porosity: 30%) as the ultraviolet light-reflecting coating layer was stacked on the substrate layer-1 to prepare a sample-1.

### Preparation Example 2

A sample-2 was prepared in the same manner as in Preparation Example 1, except that the UMPE film (thickness: 200 μm, average pore diameter: 17 μm, and porosity: 30%) was used as the ultraviolet light-reflecting coating layer.

### Preparation Example 3

A sample-3 was prepared in the same manner as in Preparation Example 1, except that the UMPE film (thickness: 300 μm, average pore diameter: 17 μm, and porosity: 30%) was used as the ultraviolet light-reflecting coating layer.

### Test Example 1. Evaluation of Radiational Cooling Performance

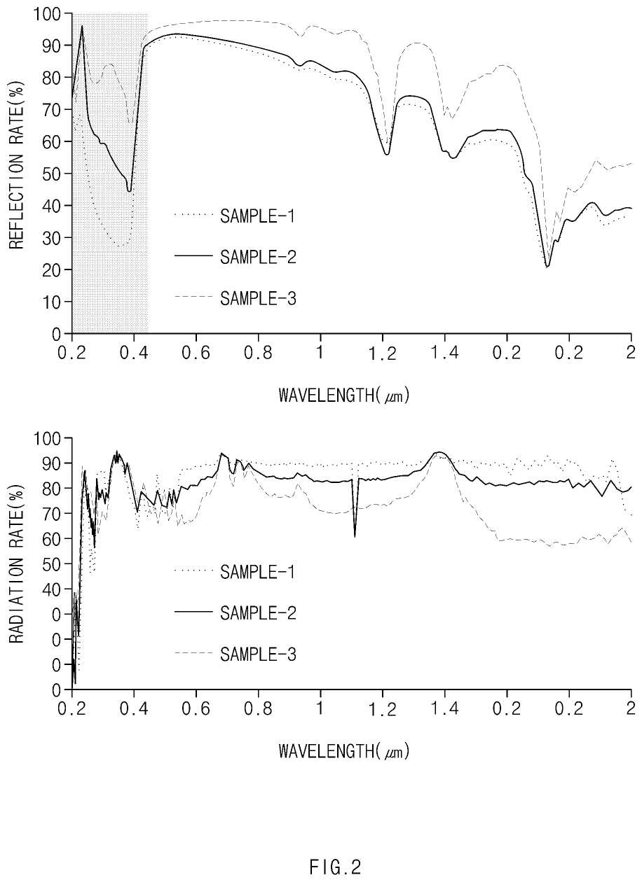

With respect to the sample-1 of Preparation Example 1, the sample-2 of Preparation Example 2, and the sample-3 of Preparation Example 3, a reflection rate for the wavelength in the range from 200 to 400 nm (the ultraviolet light), a reflection rate for the wavelength in the range from 400 to 700 nm (the visible light), and a radiation rate for a wavelength in a range from 700 nm to 20 μm (the infrared light) were measured, and results thereof are shown in graphs 250 in FIG. 2.

As shown in FIG. 2, as the thickness of the UMPE film, which is the ultraviolet light-reflecting coating layer, increases, the reflection rate for the wavelength in the range from 200 to 400 nm (the ultraviolet light) increased, but a radiation rate for a wavelength in a range from 2 to 20 μm (the infrared light) decreased.

### Example 1. Preparation of Laminate-1

BaSO₄ (band gap: 5.0 eV and average particle diameter: 300 nm) was placed as the ultraviolet light-reflecting inorganic material in pores of the UMPE film of the sample-1 of Preparation Example 1.

Specifically, in a method of adding 5 g of BaSO₄ to 100 ml of ethanol and stirring the mixture for 30 minutes, then, spraying an adhesive spray onto the UMPE film, and then, spraying the ethanol mixed with the BaSO₄ onto the UMPE film, BaSO₄ was placed in the pores of the UMPE film by a weight of 0.1 g/ml to prepare a laminate-1.

### Example 2. Preparation of Laminate-2

A laminate-2 was prepared in the same manner as in Example 1, except that the sample-2 of Preparation Example 2 was used instead of the sample-1 of Preparation Example 1.

### Example 3. Preparation of Laminate-3

A laminate-3 was prepared in the same manner as in Example 1, except that the sample-3 of Preparation Example 3 was used instead of the sample-1 of Preparation Example 1.

### Test Example 2. Evaluation of Radiational Cooling Performance

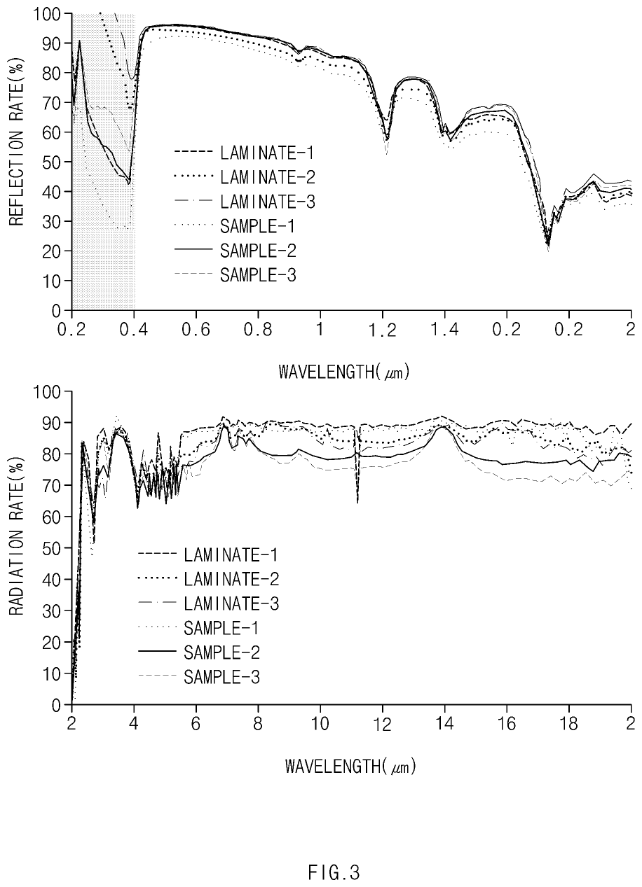

With respect to the sample-1 of Preparation Example 1, the sample-2 of Preparation Example 2, the sample-3 of Preparation Example 3, the laminate-1 of Example 1, the laminate-2 of Example 2, and the laminate-3 of Example 3, the reflection rate for the wavelength in the range from 200 to 400 nm (the ultraviolet light), the reflection rate for the wavelength in the range from 400 to 700 nm (the visible light), and the radiation rate for the wavelength in the range from 700 nm to 20 μm (the infrared light) were measured, and results thereof are shown in FIG. 3.

As shown in FIG. 3, compared to the samples of Preparation Examples, the laminates of Examples were remarkably excellent in the reflection rate for the wavelength in the range from 200 to 400 nm (the ultraviolet light) and a radiation rate for a wavelength in a range from 8 to 13 μm (the infrared light) because of the ultraviolet light-reflecting inorganic material in the pores.

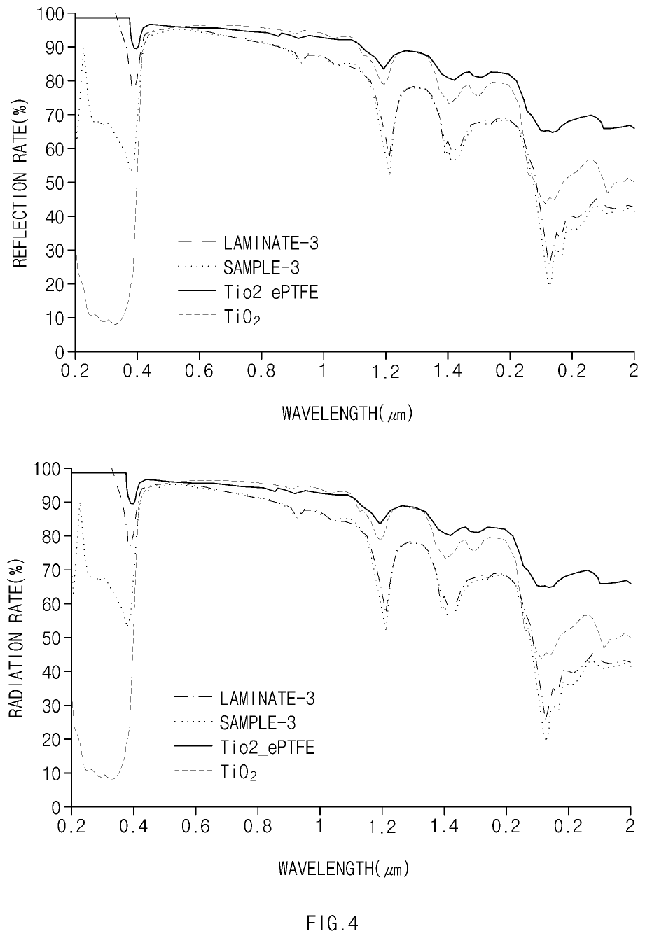

In addition, with respect to the TiO₂ (average particle diameter: 360 nm) as the visible light-reflecting inorganic material, the sample-3 of Preparation Example 3, and the laminate-3 of Example 3, the reflection rate for the wavelength in the range from 200 to 400 nm (the ultraviolet light), the reflection rate for the wavelength in the range from 400 to 700 nm (visible light), and the radiation rate for the wavelength in the range from 700 nm to 20 μm (the infrared light) were measured, and results thereof are shown in FIG. 4.

As shown in FIG. 4, the laminate-3 of Example 3 had the remarkably excellent reflection rate of about 100% for the wavelength in the range from 200 to 400 nm (the ultraviolet light), and had an excellent radiation rate equal to or higher than 80% for a wavelength in a range from 8 to 20 μm (the infrared light). In addition, the laminate-3 of Example 3 was excellent in the reflection rate for the wavelength in the range from 400 to 700 nm (the visible light).

The laminate for the radiational cooling according to the present disclosure has the excellent flexibility, is easy to be controlled in the thickness, and has the excellent infrared light radiability and ultraviolet light reflectivity to have the excellent radiational cooling ability. In addition, the laminate for the radiational cooling has the very excellent radiational cooling ability because of low absorption of heat energy resulted from convection, so that the laminate for the radiational cooling may be suitably used as a material in various fields requiring a material having the excellent radiational cooling ability, such as a vehicle.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A laminate for radiational cooling, the laminate comprising:
a substrate layer containing a matrix of an infrared light-radiating polymer containing polycarbonate-based polyurethane and particles of a visible light-reflecting inorganic material;
an ultraviolet light-reflecting coating layer formed on the substrate layer and containing an ultra-high molecular polyolefin-based polymer, wherein the ultraviolet light-reflecting coating layer is porous; and
particles of an ultraviolet light-reflecting inorganic material disposed in pores of the ultraviolet light-reflecting coating layer.

2. The laminate of claim 1, wherein the visible light-reflecting inorganic material includes at least one selected from a group consisting of TiO₂, SiO₂, ZnO, CaCO₃, BaSO₄, and Al₂O₃.

3. The laminate of claim 1, wherein the particles of the visible light-reflecting inorganic material have an average particle diameter in a range from 50 to 1,500 nm.

4. The laminate of claim 1, wherein the polycarbonate-based polyurethane has a weight-average molecular weight in a range from 450 to 4,500 g/mol.

5. The laminate of claim 1, wherein the substrate layer contains the visible light-reflecting inorganic material and the infrared light-radiating polymer in a weight ratio of 0.5 to 5:1.

6. The laminate of claim 1, wherein the ultra-high molecular polyolefin-based polymer in the ultraviolet light-reflecting coating layer includes ultra-high molecular weight polyethylene (UMPE).

7. The laminate of claim 1, wherein the ultra-high molecular polyolefin-based polymer in the ultraviolet light-reflecting coating layer has a weight-average molecular weight in a range from 3,000,000 to 6,000,000 g/mol.

8. The laminate of claim 1, wherein the ultraviolet light-reflecting coating layer contains the pores having an average diameter in a range from 5 to 25 μm and has a porosity in a range from 20 to 40%.

9. The laminate of claim 1, wherein a weight of the particles of the ultraviolet light-reflecting inorganic material in a unit volume of the ultraviolet light-reflecting coating layer is in a range from 0.1 to 1 g/ml.

10. The laminate of claim 1, wherein the ultraviolet light-reflecting inorganic material has a band gap greater than 4.0 eV.

11. The laminate of claim 1, wherein the ultraviolet light-reflecting inorganic material includes at least one selected from a group consisting of BaSO₄, CaCO₃, and Al₂O₃.

12. The laminate of claim 1, wherein the particles of the ultraviolet light-reflecting inorganic material have an average particle diameter in a range from 100 to 500 nm.

13. The laminate of claim 1, wherein a reflection rate for a wavelength in a range from 200 to 400 nm is in a range from 65 to 99%, and a reflection rate for a wavelength in a range from 400 to 700 nm is in a range from 65 to 99%.

14. A radiational cooling material containing the laminate for the radiational cooling of claim 1.

15. A vehicle containing the radiational cooling material of claim 14.
